(19) United States
(12) Patent Application Publication
(10) Pub. No.: US 2025/0010441 A1
(43) Pub. Date: Jan. 9, 2025

(54) Systems and Methods for Power Tool Operation Assessment

(71) Applicant: Milwaukee Electric Tool Corporation, Brookfield, WI (US)

(72) Inventors: Anton J. Gumina, Menomonee Falls, WI (US); Brendan M. Anderson, Chicago, IL (US)

(21) Appl. No.: 18/754,866

(22) Filed: Jun. 26, 2024

Related U.S. Application Data
(60) Provisional application No. 63/511,948, filed on Jul. 5, 2023.

(51) Int. Cl. B25B 23/14; B25B 23/147

(52) U.S. Cl. CPC B25B 23/147

(57) ABSTRACT

A power tool including a shear wrench and method for tool operation assessment is disclosed. A shear wrench may include a motor, a current sensor configured to detect motor current, and an electronic controller including a processor and a memory. The electronic controller may drive the motor in response to an actuation, receive current data from the current sensor when the motor is driven in response to the actuation, and generate a shear indication indicating detection of a shear based on analysis of the current data. Other aspects, embodiment, and features are also claimed and described.

### RELATED APPLICATIONS

The present application claims the benefit of and priority to U.S. Provisional Patent App. No. 63/511,948, filed on Jul. 5, 2023, the entire disclosure of which is incorporated herein by reference.

### SUMMARY

Some embodiments of the disclosure provide a shear wrench with a motor, a current sensor configured to detect motor current, and an electronic controller. The electronic controller may include a processor and a memory. The electronic controller may be configured to drive the motor in response to an actuation, receive current data from the current sensor when the motor is driven in response to the actuation, and generate a shear indication indicating detection of a shear based on analysis of the current data.

Some embodiments of the disclosure provide a method. The method may include driving a motor of the power tool responsive to an actuation of the power tool; receiving current data from a current sensor of the power tool when the motor of the power tool is driven responsive to detecting the actuation of the power tool; analyzing the current data from the current sensor; and generating a shear indication indicating detection of a shear based on the analysis of the current data from the current sensor.

Some embodiments of the disclosure provide a non-transitory computer-readable storage medium. The computer-readable medium may have instructions stored thereon that, when executed by a processor, cause the processor to drive a motor of a power tool responsive to an actuation of the power tool; receive current data from a current sensor of the power tool when the motor of the power tool is driven responsive to detecting the actuation of the power tool; and generate a shear indication indicating detection of a shear based on analysis of the current data from the current sensor.

At least in some embodiments described herein, improved power tools, systems, and methods are provided that may reduce energy consumption to track the power tool and/or provide an accurate location of the power tool.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is a schematic illustration of a tool system, according to some embodiments.

FIG. 2 is a block diagram of a shear wrench, according to some embodiments.

FIG. 3 is a flowchart of a process for shear wrench operation assessment, according to some embodiments.

FIG. 4A is a schematic illustration of a current graph to analyze a shear wrench based on one threshold, according to some embodiments.

FIG. 4B is an example current graph to analyze a shear wrench based on one threshold, according to some embodiments.

FIG. 5A is a schematic illustration of a current graph to analyze a shear wrench based on two thresholds, according to some embodiments.

FIG. 5B is an example current graph to analyze a shear wrench based on two thresholds, according to some embodiments.

FIG. 6A is a schematic illustration of a current graph to analyze a shear wrench based on a current change rate, according to some embodiments.

FIG. 6B is an example current graph to analyze a shear wrench based on a current change rate according to some embodiments.

FIG. 7A is a schematic illustration of an example report of shear wrench operation assessment, according to some embodiments.

FIG. 7B is a schematic illustration of another example report of shear wrench operation assessment, according to some embodiments.

### DETAILED DESCRIPTION

Power tools (e.g., a shear wrench, an impact driver, a power drill, a hammer drill, a pipe cutter, a sander, a nailer, a grease gun, or any other suitable power tool, which is driven by electricity) generally enhance performance, speed, efficiency, and accuracy compared to manual tools. Some power tools including shear wrenches are portable such that the power tools can be used anywhere at worksites or any other locations. Further, power tools can be versatile such that different tools or sockets can be used for different purposes or different fastener sizes. However, it is hard to understand or gauge the power tool operation (e.g., how many sockets are used per day/week/month/lifetime, how many fasteners are used per day/week/month/lifetime, etc.). Accordingly, power tool operation assessment may be desirable to accurately gauge and assess power tool lifetime, efficiency, and effectiveness of the power tool and improve jobsite productivity.

Some embodiments described herein provide solutions to these problems by providing improved systems, power tools, and methods for efficiently and accurately assess power tool operation. For example, as described herein, the improved systems, shear wrenches, and methods can perform shear wrench operation assessment to generate a shear indication (e.g., a fastener size, a number of fasteners sheared, a shear time stamps, shear location, etc.) based on one or more current thresholds or one or more current changing rates. It should be appreciated that the shear wrench is not a limiting example for the power tool operation assessment. The power tool operation assessment can be used for any other suitable power tools.

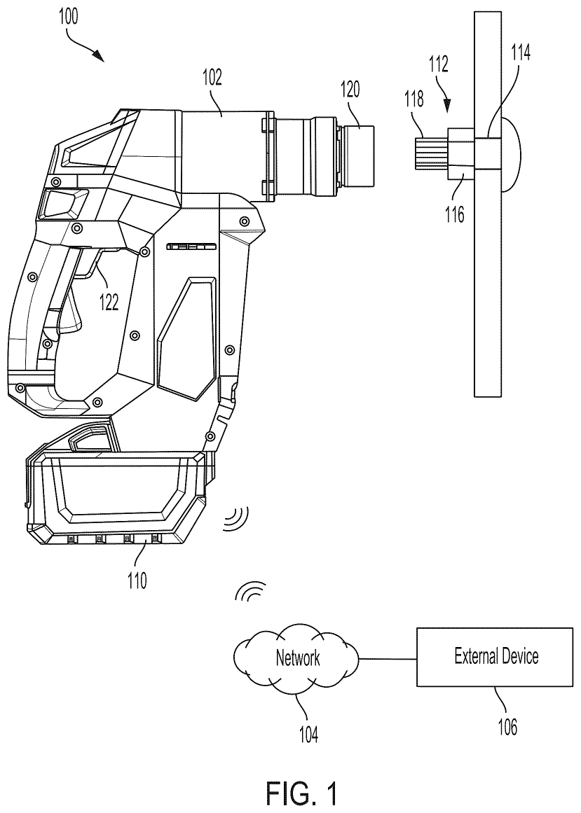

FIG. 1 illustrates a tool operation assessment system 100 according to some embodiments. The tool operation assessment system 100 includes a shear wrench 102, a network 104, and/or an external device 106.

The shear wrench 102 is, for example, a power tool powered by a battery pack 110 or any other power source. The shear wrench 102 can be used in the manufacture of high-strength and/or high-load buildings (e.g., metal buildings, skyscrapers, etc.) to control the tension (e.g., torque, tightness) of a fastener 112. In some examples, the fastener 112 can include a bolt 114, a nut 116, a spline 118, and/or a washer (not shown in FIG. 1). The spline 118 is initially connected to the bolt 114 and can be removed from the bolt 114 by a shear operation of the shear wrench 102. The shear wrench 102 can include an outer socket 120 to be engaged over the nut 116 to rotate the nut 116 and an inner socket (not shown in FIG. 1) configured to be fit over the spline 118 to hold or rotate the spline 118. In further examples, the outer socket 120 and/or the inner socket of the shear wrench 102 can be replaced to different types of the outer socket 120 and/or the inner socket depending on the size or shape of the nut 116 and/or the spline 118.

In some examples, when a trigger 122 of the shear wrench 102 is pulled, a motor (not shown in FIG. 1) is driven to rotate the outer socket 120 in response to an actuation (i.e., the trigger pull). Then, the outer socket 120 rotates the nut 116 while the inner socket firmly holds or rotate the spline 118 until the predetermined tension is reached. The inner socket of the shear wrench 102 may shear off (e.g., remove) the spline 118 from the bolt 114 by rotating the inner socket and the spline 118. When the motor is driven to reach the predetermined tension, the current flowing from the battery pack 110 or any other power source increases. When the predetermined tension is reached and the spline 118 is removed, the current flowing from the battery pack 110 or any other power source decreases. In some examples, the wrench 102 may analyze the current data to generate a shear indication indicating detection of a shear. In some examples, the shear indication can further include a bolt size, a socket size, a number of sheared bolts, or any other suitable indication. In some examples, the wrench 102 can remove the spline 118 from the inner socket (e.g., using another trigger). It should be appreciated that any other power tool powered by the battery pack 110 or any other power source can be used in the tool operation assessment system 100 such that the current from the battery pack 110 increases in the tool operation and decreases after the tool operation.

In some examples, the shear wrench 102 can wirelessly communicate with the external device 106 via the network 104. For example, the shear wrench 102 can transmit, wirelessly, shear data (e.g., shear indication) to the external device 106 and/or receive configuration data indicative of one or more thresholds used in the analysis of the current data. However, in some examples, the shear wrench 102 communicates via wired connection with the external device 106.

The network 104 includes, for example, one or more of a local area network (LAN) (e.g., a Wi-Fi network), a wide area network (WAN) (e.g., a cellular network or the Internet), or another communication network configuration. The network 104 may include one or more network nodes. A network node may include a router, hub, a personal computer, a server, a host, or any other suitable device to provide network resources. The network 104 provides a connection between the external device 106 and the shear wrench 102.

The external device 106 includes, for example, an external electronic processor and an external memory. Although illustrated as a single device, the external device 106 may be a distributed device in which the processor and memory are distributed among two or more units that are communicatively coupled (e.g., via the network 104). The external device 106 may maintain a database for the system (e.g., on the server memory). The external device 106 may store configuration data (e.g., one or more thresholds, one or more current changing rates, etc.) and/or shear wrench data (e.g., a bolt size, a socket size, etc.) in the database. The external device 106 may receive shear indication (e.g., a bolt size, a socket size, a number of sheared bolts)

The particular numbers and types of components with the system 100 of FIG. 1 are merely used as an example for discussion purposes; additional and/or different types of power tool devices, networks 104, and servers 106 can be present in some embodiments of the system 100.

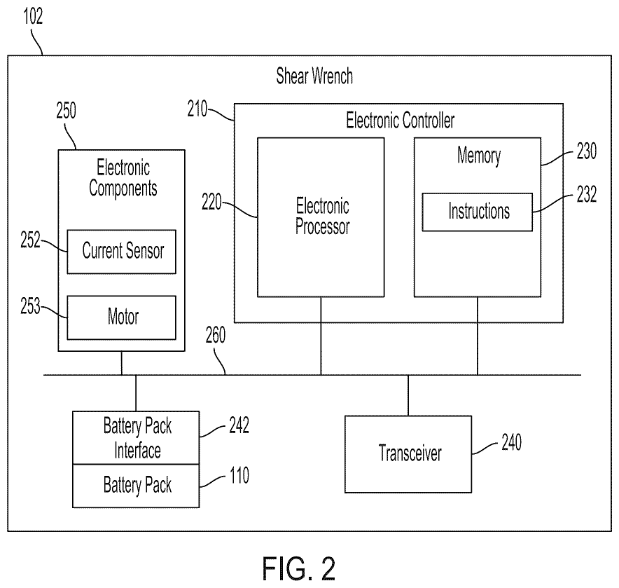

FIG. 2 is a block diagram of an example of a shear wrench 102. In some examples, the shear wrench 102 may include an electronic controller 210, a transceiver 240, a power tool battery pack 110, and/or electronic components 250. The electronic controller 210 may include an electronic processor 220 and a memory 230. The electronic processor 220, the memory 230, and the transceiver 240 may communicate over one or more control and/or data buses (for example, a device communication bus 260). The memory 230 may include read-only memory (ROM), random access memory (RAM), other non-transitory computer-readable media, or a combination thereof. The memory 230 may include instructions 232 for the electronic processor 220 to execute.

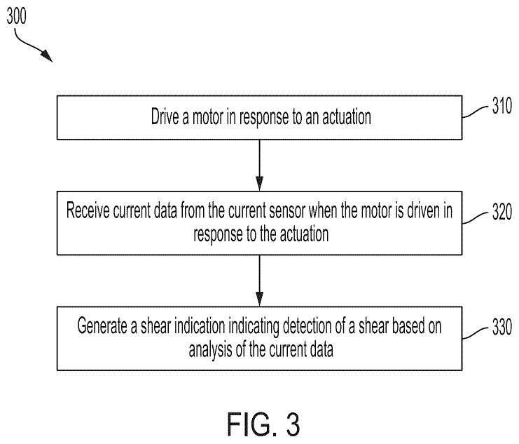

The electronic processor 220 may be configured to communicate with the memory 230 to store data and retrieve stored data. The electronic processor 220 may be configured to receive the instructions 232 and data from the memory 230 and execute, among other things, the instructions 232. In some examples, through execution of the instructions 232 by the electronic processor 220, the electronic controller 210 may perform one or more of the methods described herein. For example, the instructions 232 may include software executable by the electronic processor 220 to enable the electronic controller 210 to, among other things, implement the various functions of the electronic controller 210 described herein, including the functions of the electronic controller 210 described with respect to process 300 of FIG. 3.

The transceiver 240 may be communicatively coupled to the electronic controller 210 (e.g., via the bus 260). The transceiver 240 enables the electronic controller 210 (and, thus, the shear wrench 102) to communicate with other devices (e.g., an external device 106). In some examples, the transceiver 240 further includes a GNSS receiver configured to receive signals from GNSS satellites and/or land-based transmitters, determine a location of the shear wrench 102 from the received signals, and provide a location of the shear wrench 102 to the electronic controller 210.

In some embodiments, the shear wrench 102 may also optionally include a power tool battery pack interface 242 that is configured to selectively receive and interface with a power tool battery pack 110. The pack interface 242 may include one or more power terminals and, in some cases, one or more communication terminals that interface with respective power and/or communication terminals of the power tool battery pack 110. The power tool battery pack 110 may include one or more battery cells of various chemistries, such as lithium-ion (Li-Ion), nickel cadmium (Ni-Cad), and the like. The power tool battery pack 110 may further selectively latch and unlatch (e.g., with a spring-biased latching mechanism) to the shear wrench 102 to prevent unintentional detachment. The power tool battery pack 110 may further include a pack electronic controller (pack controller) including a processor and a memory. The pack controller may be configured similarly to the electronic controller 210 of the shear wrench 102. The pack controller may be configured to regulate charging and discharging of the battery cells, and/or to communicate with the electronic controller 210. In other embodiments, the one or more power terminals of the pack interface 242 can interface with the mains electricity to operate the shear wrench 102. It should be appreciated that the power source for the shear wrench 102 is not limited to the battery pack 110 and can include any other suitable power source (e.g., mains electricity).

In some embodiments, the shear wrench 102 also includes additional electronic components 250. In some examples, the electronic component 250 may include a current sensor 252 and a motor 253. The current sensor 252 may be configured to detect current from the battery pack 110 or other power source to a motor in the shear wrench. In some examples, the current sensor 252 can include a current sense resistor to measure current from the battery pack 110 to the motor 253. For example, the current sensor 252 may convert the current to voltage. The current sense resistor may include a low resistance value to cause an insignificant voltage drop, which is proportional to the current. Thus, based on the voltage drop, the electronic controller 210 via the current sensor 252 can measure and determine the current flowing from the battery pack 110 to the motor 253 of the shear wrench 102. Then, the current sensor 252 may output current data to the electronic controller 210. Based on the output of the current sensor 252, the electronic controller 210 may sample the current data and generate a shear indication.

In some examples, the motor 253 is configured to rotate the outer socket 120 and/or the inner socket. The electronic components 250 may also include additional circuitry to control the motor 253. For example, the electronic components 250 may include an inverter bridge controlled with pulse width modulated signals (generated by the controller 210) to drive the motor 253. The motor 253 may be, for example, a brushed or brushless motor.

In some examples, the shear wrench 102 can further include other components used for operation assessment and data collection (e.g., a GNSS receiver as previously described, a clock, etc.). For example, the electronic controller 210 can determine the location and the time of the tool implement (e.g., shearing off the spline 118 of the fastener 112). In some examples, the shear wrench 102 can further include a clock. The clock can be a real time clock, a timer, or any other suitable clock to measure time. The clock may be integrated into the electronic controller 210, may be a separate integrated circuit in communication with the electronic controller 210, or be provided in another arrangement. For example, the clock in the shear wrench 102 can be used to record when each bolt is snapped by the shear wrench 102, and the electronic processor along with the clock can record the number of bolts snapped for a predetermined period of time (e.g., per day, per week, per month, per year, etc.). In further examples, the clock can record the time that the shear wrench 102 is in the field (e.g., on a particular project, on a particular day, indicating the overall use since, or other time period) or any other suitable metric. For example, the clock in the shear wrench 102 can be used to record when, and, in some cases, infer where, each bolt is snapped by the shear wrench 102 (e.g., along with the GNSS receiver). Thus, the clock can be used to measure how many bolts are snapped over time by the user in the field or by the jobsite. For example, jobsite managers could use the clock as a means to record efficiencies of different crews using different tools. In some examples, the efficiency can be measured by the number of bolts snapped divided by the time in the field.

FIG. 3 illustrates a process 300 for shear wrench operation assessment of a shear wrench 102. The process 300 is described below as being carried out by the shear wrench 102 or any other suitable power tool device of the tool operation assessment system 100 as illustrated in FIGS. 1 and 2. For example, the blocks of the process 300 below are described as being executed by the electronic controller 210 of the shear wrench 102. However, in some embodiments, the process 300 is implemented by another device and/or in another system having additional, fewer, and/or alternative components. Additionally, although the blocks of the process 300 are illustrated in a particular order, in some embodiments, one or more of the blocks may be executed partially or entirely in parallel, may be executed in a different order than illustrated in FIG. 3, or may be bypassed.

In block 310, the electronic controller 210 drives a motor of the shear wrench 102 in response to an actuation (e.g., a trigger pull). Referring again to FIG. 1, in some examples, when a user pulls the trigger 122 of the shear wrench 102, the electronic controller 210 may detect actuation of the trigger 122 and, in response, control current from the battery pack 110 to drive the motor. For example, actuating or pulling the trigger 122 may provide a voltage signal to the electronic controller 210 (which may vary based on the amount of pull), and the electronic controller 210 may detect the actuation based on the voltage signal. The electronic controller 210 drives the motor to rotate the outer socket 120 to rotate the nut 116 until the predetermined tension is reached. Further, the electronic controller 210 may drive the same motor or a different motor of the shear wrench 102 to rotate the inner socket, which holds the spline 118 of the fastener 112, to remove the spline 118 from the fastener 112. In further examples, the electronic controller 210 may drive the outer socket 120 to rotate the nut 116 in a direction and the inner socket to rotate the alpine 118 in an opposite direction until the spline 118 is removed.

In block 320, the electronic controller 210 receives current data from a current sensor 252 of the shear wrench 200 when the motor is driven in response to the actuation. In some examples, the actuation may occur when the user pulls the trigger 122 of the shear wrench 102. In response to the actuation, the current sensor 252 detects the current and provides the current data to the electronic controller 210. In some examples, the current data may include the amount of the current flowing from the battery pack 110 to the motor. For example, the amount of the current may change when the electronic controller 210 drives the motor. In some examples, the electronic controller 210 controls the current to drive the motor such that the current increases until the predetermined tension is reached and decreases after the predetermined tension is reached or the spline 118 of the fastener 112 is removed. Further, the amount of the current flowing from the battery pack 110 to the motor can be different when the shear wrench uses different sizes (e.g., ½″, ⅝″, ¾″, ⅞″, 1″, 1⅛″, 1¼″, etc.) of the outer socket 120 and/or the inner socket for corresponding nuts 116 and/or splines 118.

In block 330, the electronic controller 210 generates a shear indication indicating detection of a shear or a removal of the spline 118 based on analysis of the current data. For example, the electronic controller 210 can detect the shear by analyzing the current data based on configuration data (e.g., one threshold, two thresholds, and a current change rate). In some embodiments, the shear indication can indicate a bolt size, a socket size, and/or a number of sheared bolts. In some embodiments, the electronic controller 210 may transmit, wirelessly, shear data (e.g., the shear indication) to an external device (e.g., the external device 106 in FIG. 1). In further embodiments, the electronic controller 210 may receive, wirelessly, the configuration from an external device (e.g., the external device 106 in FIG. 1). The configuration data may indicate at least one threshold and/or at least one predetermined current change used in the analysis of the current data to generate the shear indication.

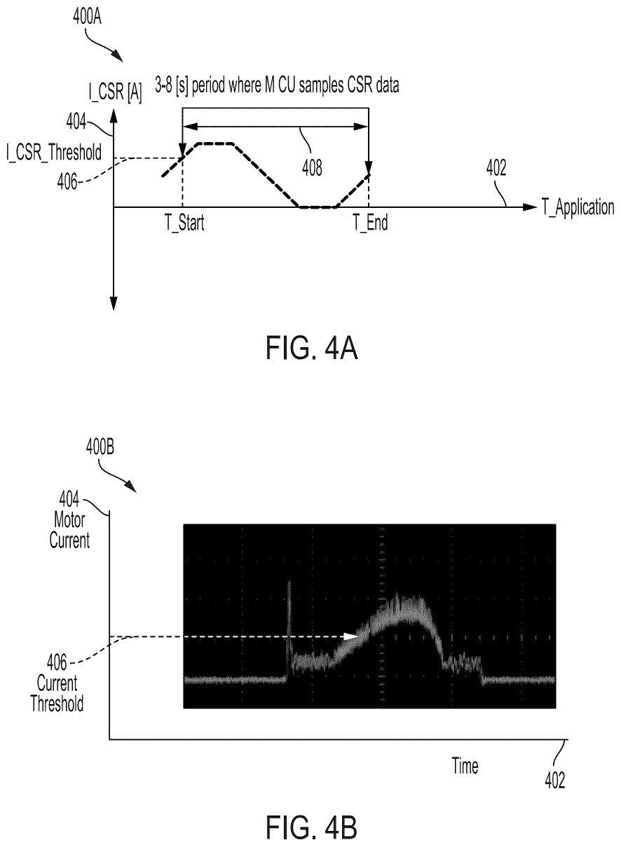

In some embodiments, the configuration data can include one threshold to detect the shear or the removal of the spline 118 from the bolt 114 and to be used in the analysis of the current data to generate the shear indication. FIGS. 4A and 4B illustrate current graphs 400A, 400B to analyze a shear based on one threshold. In the current graph, the x-axis 402 indicates time while the y-axis 404 indicates motor current flowing from the battery pack 110 to the motor of the shear wrench 102. In some examples, the motor current can include battery current and phase current. The threshold 406 is a predetermine amount of current. In some examples, the electronic controller 210 may determine a shear when the current is the same as or higher than the threshold. In other examples, the electronic controller 210 may determine a shear when the current crosses or passes the threshold 406. For example, the electronic controller 210 may determine a shear when the current increases and crosses the threshold 406 from a first current at a first time below the threshold 406 to a second current at a second and subsequent time above the threshold 406. In some examples, the electronic controller 210 may count the number of shears or sheared bolts based on the determined shear. Then, the electronic controller 210 may set an application time 408 after the current meets or crosses the threshold 406. In some examples, the application time 408 is a pre-determined time period (e.g., 3-8 seconds) after the current meets or crosses the threshold 406. In some examples, the electronic controller 210 may start sampling the current data when the current is equal or crosses the threshold 406 and stop sampling the current data after the application time 408 to generate multiple samples for the application time. In some examples, sampling the current data indicates reducing the current data of a continuous-time current signal to discrete-time current samples.

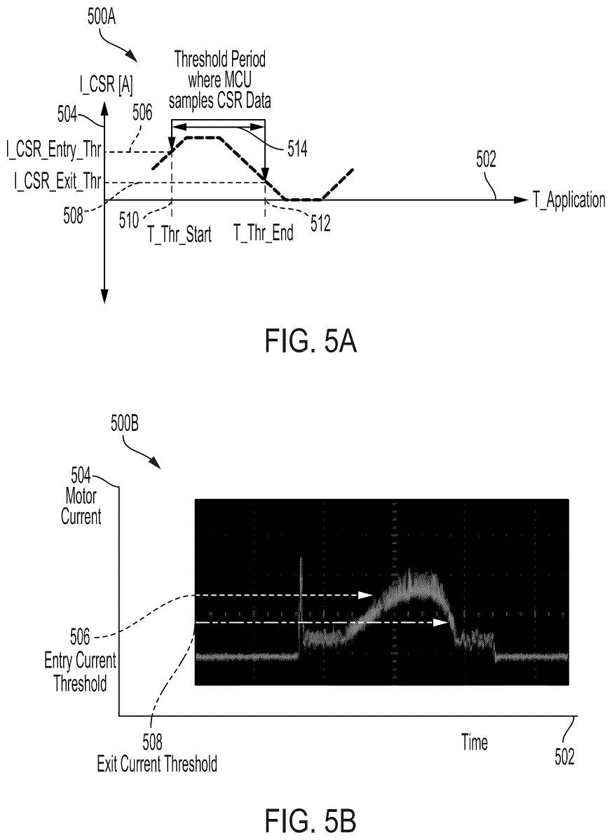

In further embodiments, the configuration data can include two thresholds to detect the shear and to be used in the analysis of the current data to generate the shear indication. FIGS. 5A and 5B illustrate current graphs 500A, 500B to analyze a shear based on one threshold. In the current graph, the x-axis 502 indicates time while the y-axis 504 indicates motor current flowing from the battery pack 110 to the motor of the shear wrench 102. In the embodiments, two thresholds (i.e., an entry current threshold 506, an exit current threshold 508) define the application time 510 to sample the current data to generate the shear indication. In some examples, the electronic controller 210 may determine a shear when the current crosses the entry current threshold 506 and the exit current threshold 508. For example, when the current increases, the current crosses the entry current threshold 506 at an entry time 510 while the current decreases, the current crosses the exit current threshold 508 at an exit time 512. In the embodiments, the electronic controller 210 may not determine the shear when the current only crosses one threshold (i.e., the entry current threshold 506 or the exit current threshold 508). In some examples, the entry current threshold 506 may be greater than the current when the trigger 122 is not pulled (e.g., during no-load activity). In some examples, the electronic controller 210 may set the application time 514 between the entry time 510 and the exit time 512. For examples, the electronic controller 210 may start sampling the current data when the current crosses the entry current threshold 506 from below to over the entry current threshold 506 and stop sampling the current data when the current crosses the exit current threshold 508 from over to below the exit current threshold 508 to generate multiple samples of the current data for the application time. In further examples, the electronic controller 210 may determine a shear when an average of the multiple samples is equal to or is greater than a predetermined current average. In the examples, the electronic controller 210 may not determine the shear not only based on the current crossing the entry current threshold 506 and the exit current 508 but also based on the average of the multiple samples of the current data for the application time. In some examples, the electronic controller 210 may count the number of shears or sheared bolts based on the determined shear.

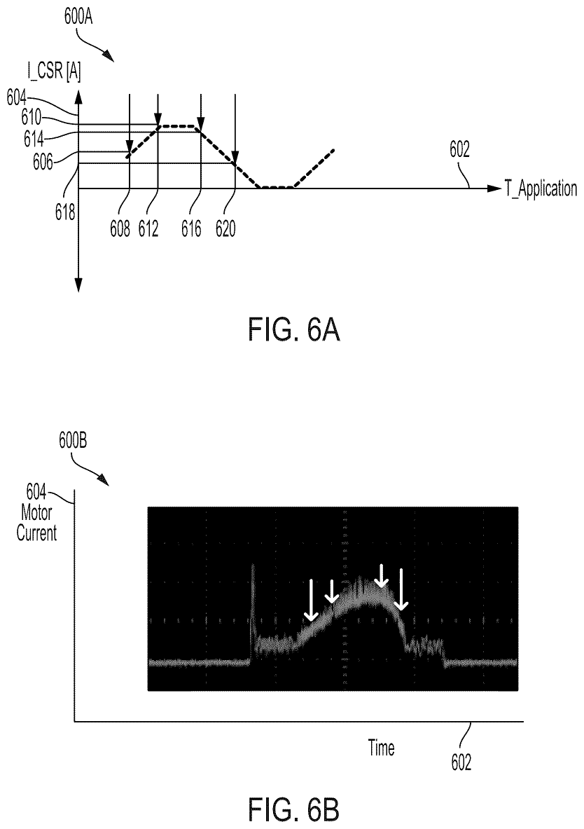

In even further embodiments, the configuration data can include at least one current change rate to detect the shear and to be used in the analysis of the current data to generate the shear indication. FIGS. 6A and 6B illustrate current graphs 600A, 600B to analyze a shear based on at least one current change rate. In the current graph, the x-axis 602 indicates time while the y-axis 604 indicates motor current flowing from the battery pack 110 to the motor of the shear wrench 102. In the embodiments, the electronic controller 210 can determine a first current change rate between a first current 606 at a first time 608 and a second current 610 at a second time 612 in the current data. In some examples, the first current change rate can be calculated by: (the second current 610—the first current 606)/(the second time 612—the first time 608). In some examples, the electronic controller 210 may determine a shear by comparing the first current change rate with a first predetermined current change. In further examples, the electronic controller may determine the shear further based on a second current change rate. For example, the electronic controller 210 can determine the second current change rate between a third current 614 at a first time 616 and a fourth current 618 at a fourth time 620 in the current data. In some examples, the second current change rate can be calculated by: (the fourth current 618—the third current 614)/(the fourth time 620—the third time 616). In some examples, the electronic controller 210 may determine a shear by comparing the second current change rate with a second predetermined current change. In further examples, the electronic controller 210 may determine a shear by comparing both of the first and second current change rates with both of the first and second predetermined current change rates, respectively. If the first current change rate is a rate when the current increases, the second current change rate is a rate when the current decreases. In some examples, the electronic controller 210 may start sampling the current data at the first time 608 and stop sampling the current data at the fourth time 620 to generate multiple samples for the application time. In some examples, the application time in the embodiment is from the first time 608 to the fourth time 620.

In further embodiments, the electronic controller 210 may determine a shear when the current in the current data is over a threshold for a predetermined period of time. In the embodiments, the application time may be the predetermined period of time or the whole period of time of the current being over the threshold. Thus, the electronic controller 210 may generates multiple samples for the application time.

In some embodiments, based on the multiple samples in the application time, the electronic controller 210 may determine an effective current of the multiple samples. In some examples, the effective current may include a root mean square (RMS) of the multiple samples. For example, the effective current of the multiple samples may be expressed as:

$${Current}_{RMS} = \sqrt{\frac{{Sample}_{1}^{2} + {Sample}_{2}^{2} + … + {Sample}_{n}^{2}}{n}} ,$$

where n is the total number of samples, and Sampleₙ is the current value of Sampleₙ. Then, the electronic controller 210 may generate the shear indication based on the effective current. In some examples, the shear indication can include a bolt size, a socket size, and/or a number of sheared bolts. In some examples, the effective current can be different when the socket size of the shear wrench for the corresponding bolt size is different. Thus, the electronic controller 210 can estimate the bolt size or the socket size of the outer socket 120 when the effective current within a predetermined corresponding current range. In further examples, the electronic controller 210 can count the number of sheared bolts by counting the determined shears and store the count in the memory 230 of the shear wrench 102 or the memory of the external device 106. In further examples, the electronic controller 210 can generate a time for each determined shear. In further examples, the shear indication can include a time of the shear (e.g., using the clock in the shear wrench 102).

In other embodiments, the electronic controller 210 can determine the size of the outer socket 120 based on identification indications of the outer socket 120. For example, different outer sockets 120 may have different identification indications the electronic controller 210 can read. IN some examples, the electronic controller 210 can obtain the identification indication of an outer socket 120 using a suitable communication link (e.g., electrical contacts, a Bluetooth communication link, a radio frequency identification (RFID) link, a near field communication (NFC) link, etc.) between the outer socket 120 and the shear wrench 102 (e.g., the electronic components including electrical contacts, the transceiver 240 of the shear wrench 102).

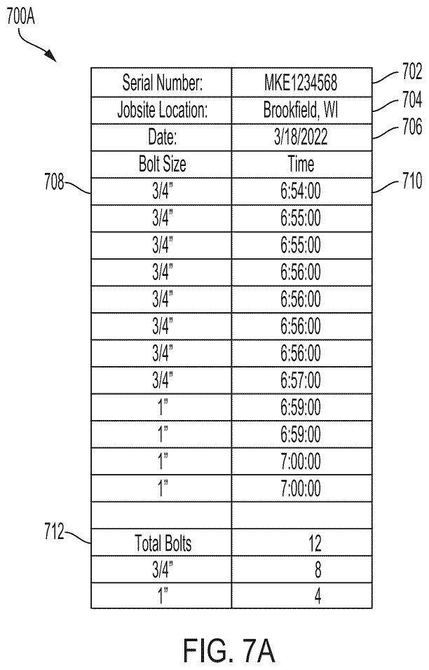

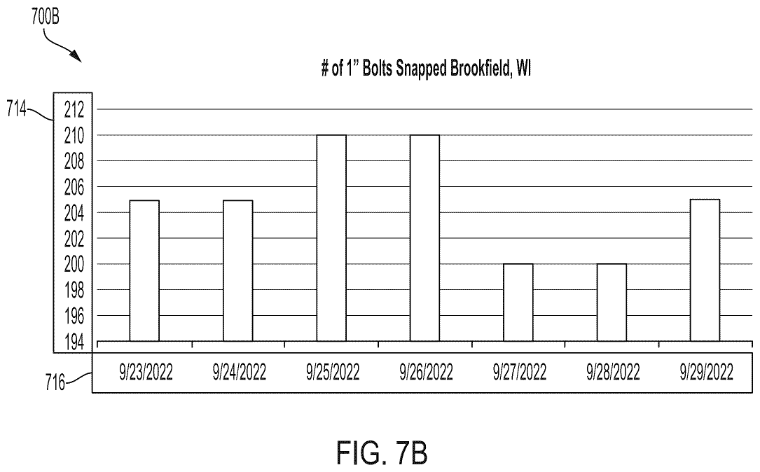

In some embodiments, the electronic controller 210 can generate a report including the shear indication as shown in FIGS. 7A and 7B. FIG. 7A shows an example report of shear wrench operation assessment. In some examples, the report 700A may include an identification 702 for the shear wrench 102. Further the report 700A may include a shear indication. The shear indication may include a location 704 of a shear, a date 706 of the shear, a bolt size 708 of the shear, and/or a time 710 of the shear. In further examples, the shear indication may include a total number 712 of entire bolts sheared in the date and/or each type of bolts sheared in the date. FIG. 7B shows another example report 700B of shear wrench operation assessment. The report 700 shows the total number 714 of bolts for a type (e.g., 1″ bolts) on each date 716. In some examples, the electronic controller 210 may transmit, wirelessly, the report to an external device (e.g., the external device 106 in FIG. 1). In other examples, the electronic controller 210 may transmit the shear indication to an external device (e.g., the external device 106 in FIG. 1), and the external device may generate the report 700A, 700B.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A shear wrench, comprising:
a motor;
a current sensor configured to detect motor current; and
an electronic controller comprising a processor and a memory, the electronic controller configured to:
drive the motor in response to an actuation;
receive current data from the current sensor when the motor is driven in response to the actuation; and
generate a shear indication indicating detection of a shear based on analysis of the current data.

2. The shear wrench of claim 1, wherein the electronic controller is configured to:
transmit, wirelessly, shear data to an external device, the shear data comprising the shear indication.

3. The shear wrench of claim 1, wherein:
for the analysis of the current data, the electronic controller is configured to sample the current data to generate a plurality of samples for an application time and determine an effective current of the plurality of samples in the application time; and
the electronic controller is configured to generate the shear indication based on the effective current.

4. The shear wrench of claim 3, wherein the electronic controller is configured to:
receive, from an external device, configuration data indicative of at least one threshold used in the analysis of the current data to generate the shear indication.

5. The shear wrench of claim 4, wherein:
the at least one threshold comprises a first threshold; and
the application time begins at a first time that occurs when an amount of current supplied to the motor crosses the first threshold and ends at a second time that occurs when a predetermined period of time elapses after the first time.

6. The shear wrench of claim 4, wherein:
the at least one threshold comprises an entry threshold and an exit threshold; and
the application time begins at a first time that occurs when an amount of current supplied to the motor crosses above the entry threshold and ends at a second time that occurs when the amount of current supplied to the motor crosses below the exit threshold.

7. The shear wrench of claim 6, wherein an average of the plurality of samples for the application time is equal to or greater than a predetermined current average.

8. The shear wrench of claim 3, wherein the electronic controller is configured to:
receive, from an external device, configuration data indicative of at least one current change rate used in the analysis of the current data to generate the shear indication.

9. The shear wrench of claim 3, wherein the shear indication comprises at least one of a bolt size, a socket size, or a number of sheared bolts.

10. The shear wrench of claim 1, wherein the shear indication comprises a time of the shear.

11. A method, comprising:
driving a motor of the power tool responsive to an actuation of the power tool;
receiving current data from a current sensor of the power tool when the motor of the power tool is driven responsive to detecting the actuation of the power tool;
analyzing the current data from the current sensor; and
generating a shear indication indicating detection of a shear based on the analysis of the current data from the current sensor.

12. The method of claim 11, wherein:
analyzing the current data comprises sampling the current data to generate a plurality of samples for an application time and determining an effective current of the plurality of samples in the application time; and
generating the shear indication comprises generating the shear indication based on the effective current.

13. The method of claim 12, wherein the application time begins at a first time that occurs when an amount of current supplied to the motor crosses a threshold and ends at a second time that occurs when a predetermined period of time elapses after the first time.

14. The method of claim 12, wherein the application time begins at a first time that occurs when an amount of current supplied to the motor crosses above an entry threshold and ends at a second time that occurs when the amount of current supplied to the motor crosses below an exit threshold.

15. The method of claim 13, comprising:
receiving the threshold from an external device that is separate from the power tool; and
transmitting shear data to the external device, the shear data comprising the shear indication and at least one of a bolt size, a socket size, a number of sheared bolts, or a time of the shear.

16. A non-transitory computer-readable storage medium having instructions stored thereon that, when executed by a processor, cause the processor to:
drive a motor of a power tool responsive to an actuation of the power tool;
receive current data from a current sensor of the power tool when the motor of the power tool is driven responsive to detecting the actuation of the power tool; and
generate a shear indication indicating detection of a shear based on analysis of the current data from the current sensor.

17. The computer-readable medium of claim 16, wherein the instructions:
for the analysis of the current data, cause the processor to sample the current data to generate a plurality of samples for an application time and determine an effective current of the plurality of samples in the application time; and
cause the processor to generate the shear indication based on the effective current.

18. The computer-readable medium of claim 17, wherein the application time begins at a first time that occurs when an amount of current supplied to the motor crosses a threshold and ends at a second time that occurs when a predetermined period of time elapses after the first time.

19. The computer-readable medium of claim 17, wherein the application time begins at a first time that occurs when an amount of current supplied to the motor crosses above an entry threshold and ends at a second time that occurs when the amount of current supplied to the motor crosses below an exit threshold.

20. The computer-readable medium of claim 19, comprising:
receiving the entry threshold and the exit threshold from an external device that is separate from the power tool; and
transmitting shear data to the external device, the shear data comprising the shear indication and at least one of a bolt size, a socket size, a number of sheared bolts, or a time of the shear.
